(19) United States
(12) Patent Application Publication
(10) Pub. No.: US 2022/0373209 A1
(43) Pub. Date: Nov. 24, 2022

(54) SYSTEM AND METHOD FOR CLIMATE CONTROL

(71) Applicant: Komfort IQ Inc., Los Angeles, CA (US)

(72) Inventor: John Ko, Los Angeles, CA (US)

(21) Appl. No.: 17/326,496

(22) Filed: May 21, 2021

(51) Int. Cl. F24F 11/63; G05B 13/02; G05B 13/04

(52) U.S. Cl. CPC F24F 11/63; G05B 13/0265; G05B 13/048

(57) ABSTRACT

A system for climate control comprises a controller, comprising a processor and a non-transitory computer-readable medium with instructions stored thereon, a plurality of sensors communicatively connected to the controller, and at least one HVAC component communicatively connected to the controller, wherein the instructions, when executed by the processor, perform steps comprising receiving sensor data from at least one sensor of the plurality of sensors, executing a machine learning model using the received sensor data as inputs, calculating a predicted temperature, humidity, or occupancy state from the machine learning model, and sending a control instruction to the at least one HVAC component based on the calculated temperature, humidity, or occupancy state. A method for training a machine learning algorithm for a climate control system and a method for HVAC control in a building are also described.

### BACKGROUND OF THE INVENTION

Currently available Heating, Ventilation, and Air Conditioning (HVAC) systems for commercial properties broadly fall into two categories. Smaller commercial systems consist of a single “zone,” which has a heating system, an air conditioning system, and a thermostat. The thermostat measures the temperature at a single point in the property, sometimes near the air intake for any recirculating ventilation system, and compares that temperature to a threshold or set of thresholds. If the temperature falls below a minimum threshold, the HVAC system will turn on the heater to warm the property. If the temperature rises above a maximum threshold, the HVAC system will turn on the air conditioner to cool it.

A second category uses Variable Air Volume (VAV) terminal boxes to combine multiple such systems within a larger commercial structure, partitioning the structure into “zones.” For example, an office building might be divided into four zones, each with its own thermostat, heater, and air conditioner or central plant. In this example, each zone will act like its own, closed, thermostatically-controlled system, with multiple settings (for example heat, cool, auto, fan only, or do nothing) and one measurement point (the thermostat) within the zone. Zones can vary widely in size, from fifty square feet to thousands of square feet.

These existing systems have numerous disadvantages. For example, even in the most granular commercial structure, airflow to multiple rooms or offices is typically turned on and off at the same time based on a single sensor, or in some cases based on temperatures measured at a few sensors positioned at different points in the structure, for example depending on whether the HVAC unit or the VAV box provides the airflow. Individual rooms or offices are restricted by centrally-determined temperature thresholds, or the whim of the occupant of the office in which the thermostat is located. Furthermore, control of such systems is limited to thermostats or a central control interface. There is no way for individual occupants of an office to exercise control over the temperature of their office or rooms.

Existing systems are also typically ignorant to external factors that can impact room temperature beyond merely turning airflow on and off. For example, room occupancy, personal preferences of an occupant, weather, cloud cover, window orientation, and the temperature of adjacent rooms are all factors that ideally should be taken into consideration in order to provide optimum comfort at maximum efficiency and energy/cost savings. Because many of these outside factors have a delayed impact on room temperature, predictive analysis is also desirable.

Furthermore, existing commercial systems do not know whether a given room is occupied or not, and even basic occupancy sensing, where available, is of limited use because one a room is occupied, it is often too late to effectively adjust the temperature for the occupant's comfort level. Additionally, occupancy sensing and room-by-room control may require different implementation details in different rooms based on the thermal characteristics of the building.

Thus, there is a need in the art for a more granular, holistic, and predictive system of air circulation and climate control, with room by room airflow control, intelligent sensors, facility modeling, and predictive analytics to increase efficiency and overall comfort. The disclosed devices and methods satisfy this need.

### SUMMARY OF THE INVENTION

In one aspect, a system for climate control comprises a controller, comprising a processor and a non-transitory computer-readable medium with instructions stored thereon, a plurality of sensors communicatively connected to the controller, and at least one HVAC component communicatively connected to the controller, wherein the instructions, when executed by the processor, perform steps comprising receiving sensor data from at least one sensor of the plurality of sensors, executing a machine learning model using the received sensor data as inputs, calculating a predicted temperature, humidity, or occupancy state from the machine learning model, and sending a control instruction to the at least one HVAC component based on the calculated temperature, humidity, or occupancy state.

In one embodiment, the at least one sensor is selected from a temperature sensor, a humidity sensor, an occupancy sensor, a light sensor, a sound sensor, a CO₂ sensor, a barometric pressure sensor, a Bluetooth beacon, a CO sensor, a PM sensor, a VOC sensor, an infrared sensor, or an ultrasonic sensor. In one embodiment, the at least one HVAC component is a building management system. In one embodiment, the at least one HVAC component is selected from a controllable duct, an air handler, or a VAV box. In one embodiment, the steps further comprise sending a control instruction to a window, an automatic window shade, a door, a light, or an electrical outlet. In one embodiment, the steps further comprise calculating a predicted occupancy state from the machine learning model, and further comprising the step of scheduling a control instruction in a controller to be sent to at least one HVAC component based on the predicted occupancy state.

In one embodiment, the at least one sensor is a thermostat. In one embodiment, the at least one sensor is positioned on a ceiling of a room. In one embodiment, the steps comprise receiving environment data from at least one data source, and executing the machine learning model using the environment data as additional inputs. In one embodiment, the environment data is selected from room geometry, window size, construction material, equipment or equipment state, user preferences, room thermodynamics, weather, cloud cover, illuminance, sound levels, air quality levels including CO₂, VOC, particle matter, time and day of week, current airflow, temperature of supply and return air, or season.

In one aspect, a method for training a machine learning algorithm for a climate control system in a building comprises collecting data from a plurality of sensors in a building, transmitting the sensor data to a controller located in the building, transmitting at least a subset of the sensor data to a remote computing device located outside the building, training a machine learning model to calculate a predictive thermodynamic, occupancy, or holistic model of at least one room in the building, transmitting the calculated model to the controller, executing the model on the controller, and transmitting the results of the executed model and additional measured sensor data to the remote computing device to refine the calculated model.

In one embodiment, the steps further comprise collecting environment data about the building, and training the machine learning model additionally based on the collected environment data. In one embodiment, the controller is a BMS. In one embodiment, the method further comprises the step of training the machine learning model to calculate a predictive thermodynamic, occupancy, or holistic model of at least a second room in the building. In one embodiment, the method further comprises the step of training the machine learning model to calculate a predictive thermodynamic, occupancy, or holistic model of an entire building based calculated models of each of the rooms in the building.

In one aspect, a method for HVAC control in a building comprises receiving a machine learning model at a controller positioned in a building, receiving data from a plurality of data sources at the controller, providing at least a subset of the received data as inputs to the machine learning model, predicting a future thermodynamic or occupancy state of at least one room in the building using the machine learning model, and transmitting a control instruction to at least one HVAC component based on the predicted thermodynamic or occupancy state.

In one embodiment, the data sources comprise sensors and environment data. In one embodiment, the sensors are selected from a temperature sensor, a humidity sensor, an occupancy sensor, a light sensor, a sound sensor, a CO₂ sensor, a barometric pressure sensor, a Bluetooth beacon, a CO sensor, a PM sensor, a VOC sensor, an infrared sensor, or an ultrasonic sensor. In one embodiment, the environment data is selected from room geometry, window size, construction material, equipment or equipment state, user preferences, room thermodynamics, weather, cloud cover, illuminance, sound levels, air quality levels including CO₂, VOC, particle matter, time and day of week, current airflow, temperature of supply and return air, or season. In one embodiment, the method further comprises recording a value of a parameter of the at least one room after transmitting the control instruction, and refining the machine learning model with the recorded parameter values.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of two exemplary rooms in a building;

FIG. 2 is a diagram of an exemplary two-room HVAC system;

FIG. 3 is a diagram of a system architecture of the disclosure;

FIG. 4A is a method of the disclosure; and

FIG. 4B is a method of the disclosure.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

Certain aspects or embodiments of the disclosure may be described in terms of any one or more systems for machine learning (ML). For example, certain embodiments may be described through illustrative examples related to neural networks. It is understood that these examples are not meant to limit the disclosure, and that any ML methodologies may be used, for example regression, classification, etc.

Aspects of the invention relate to a machine learning algorithm, machine learning engine, or neural network. A neural network may be trained based on various attributes of a climate control system, and may output a classification, model, or set of instructions based on the attributes. In some embodiments, attributes may include occupancy, user preferences, room thermodynamics, weather, cloud cover, illuminance, sound levels, air quality levels including CO2, VOC, particle matter, temperature, humidity, beacon (Bluetooth beacon to detect Bluetooth devices such as smart phones), building envelope (dual paned glass, concrete, brick, carpet), room characteristics (door, window, south facing, etc), time and day of week, current airflow, temperature of supply and return air temperature, season (winter, summer, etc), geographic location, duct size, etc. The resulting model, classification, or set of instructions may then be judged according to one or more binary classifiers or quality metrics, and the weights of the attributes may be optimized to maximize the average accuracy of the predicted binary classifiers or quality metrics. In this manner, a neural network can be trained to predict and optimize for any binary classifier or quality metric that can be experimentally measured. Examples of binary classifiers or quality metrics that a neural network can be trained on include temperature set point, room temperature, actual vs. predicted occupancy patterns, actual vs. predicted room temperature change, energy efficiency, and any other suitable type of quality metric that can be measured. In some embodiments, the neural network may have multi-task functionality and allow for simultaneous prediction and optimization of multiple quality metrics.

In embodiments that implement such a neural network, a query may be performed in various ways. A query may request the neural network identify a model to increase a desirable parameter, for example accuracy of measured room temperature.

In some embodiments, the neural network may be updated by training the neural network using a value of the desirable parameter associated with an input. Updating the neural network in this manner may improve the ability of the neural network in proposing optimal models or instructions. In some embodiments, training the neural network may include using a value of the desirable parameter associated with a known outcome. For example, in some embodiments, training the neural network may include predicting a value of the desirable parameter (for example a temperature set point or predicted occupancy) for the proposed model, comparing the predicted value to the corresponding value associated with a known model, and training the neural network based on a result of the comparison. If the predicted value is the same or substantially similar to the observed value, then the neural network may be minimally updated or not updated at all. If the predicted value differs from that of the known model, then the neural network may be substantially updated to better correct for this discrepancy. Regardless of how the neural network is retrained, the retrained neural network may be used to propose additional models.

Although the techniques of the present application are presented in the context of building modeling for HVAC control, it should be appreciated that this is a non-limiting application of these techniques as they can be applied to other types of parameters or attributes in other systems, for example fire, light safety systems, air quality monitoring and management systems, people counting systems, access control systems, energy management, facilities management, productivity management and computer networks.

As referred to herein, a “package unit” is a self-contained HVAC system that typically services smaller buildings. A “Building Management System” (or “BMS” or “BMS System”) refers to a control system for managing one or more HVAC components or functions of a building, including but not limited to chillers, boilers, ducts, controllable dampers, fans, motors, etc. In addition to the aforementioned elements, the term “HVAC component” also encompasses any other component of any HVAC system, including but not limited to a building management system, a variable refrigerant flow (VRF) system, an energy management system (EMS), a minisplit unit, a package unit, or any other HVAC system or element of an HVAC system discussed herein. A “zone damper” is a damper that is configured to control airflow into or out of a specific zone or room. In one embodiment, a zone damper as used herein is a commercially available, controllable damper.

A “Variable Air Volume” Box, or “VAV Box” is an HVAC component which controls airflow into one or more groups of zones or rooms. In one example, a VAV box includes dampers, fans, reheating coils, and/or reheating valves. A VAV controller is a controller for the VAV box which exercises control over the box and its subcomponents. As disclosed herein, any exemplary systems or methods presented as communicating instructions to an HVAC system, a BMS, or a VAV box may be considered applicable to communicating instructions to any of these or other HVAC components of a climate control system. For example, if in one example a system is presented as communicating instructions to an air conditioning unit, it is understood that the same system may also communicate with a VAV, a furnace, a BMS, a thermostat, or any other aspect of a climate control system.

A “Variable Refrigerant Flow” (VRF) system, also referred to as a variable refrigerant volume (VRV) system is an HVAC technology which uses refrigerant as the cooling and heating medium. As with minisplit units, the refrigerant in a VRF system is conditioned by a single outdoor condensing unit and circulated within a building to multiple indoor units, in some embodiments without the benefit of ductwork. VRF HVAC systems use variable motor speed and variable refrigerant flow to heat and cool, unlike standard units which use a simple on/off operation. They feature inverter compressors which operate with lower power consumption and partial heating or cooling loads, multiple indoor units on the same refrigerant loop, and a modular design offering the ability to grow the system. VRF systems also allow users to control heating and cooling individually in each room (or zone), and with some units, operate heating and cooling at the same time.

VRF HVAC systems appear as cooling-only systems, heat pump systems, and heat recovery systems, which can heat and cool at the same time. A typical VRF system includes at least one outdoor unit, several indoor units, refrigerant piping, and communication wiring. Each indoor unit may be controlled by its own wired panel and some systems offer wireless remote control and centralized controllers to enable controlling all indoor units from one location.

As referred to herein, a thermostat may refer to a basic thermostat configured to close one or more relays in response to temperature thresholds, or may alternatively refer to a smart thermostat, configured to measure more than simply temperature but also perform processing, scheduling, and/or presence detection steps. A thermostat as referred to herein may also be a sensor configured to measure one or more values including but not limited to temperature, humidity, etc. Such sensor thermostats may relay these measurements for example to a VAV or BMS, which may in turn decide which zone or zones require additional heating or cooling.

As referred to herein, a “central plant” is like a package unit except on a larger scale, and may be centrally located in a building or on a campus of buildings. In some larger systems, the central plant is where water and/or refrigerant is heated and/or cooled, then distributed to different buildings or parts of buildings. As referred to herein, an “air handling unit” (AHU) is an air distribution unit, for example a fan configured in an enclosure connected to ductwork at either or both of an intake and an exhaust, configured to pull air in from the air intake side and blow air out from one or more exhausts. In some embodiments, AHUs may be located on one or more floors of a building.

As referred to herein a “hub” is the part of an HVAC system that is the controller within the building or space. In some embodiments, a BMS may serve some or all functions of the hub, while in other embodiments a thermostat may serve some or all functions of the hub. A hub may have multiple functions, provide data connectivity from a BMS or other in-building system to one or more remote servers, run one or more machine learning models, communicate with sensors, and/or may communicate with dampers for airflow control. The hub also may facilitate communication between the sensors and the VAV box.

In one aspect, disclosed herein are systems and methods for predictive analytics in HVAC control, for example room-by-room predictive analytics in a multi-room structure. The disclosed systems and methods may result in control instructions for one or more HVAC systems, and may in some embodiments be integrated into or used as an add-on to existing BMS systems. Such systems are advantageous because in some embodiments, room-by-room modeling may reveal differences in thermodynamic characteristics even between two rooms right next to each other, which may have been difficult or impossible without collecting and processing the requisite data.

In one embodiment, an architecture of the present disclosure includes a remote server, which may be a cloud server, and a local computing device positioned in the building, close to the BMS, or in some embodiments the BMS itself. In some embodiments, data is collected from various sensors in a building, and the collected data is transmitted to the server where a model is created to represent one or more rooms in the building. The model may in some embodiments comprise a comprehensive, custom model of one or more rooms, and may in some embodiments comprise simplified, approximate models or selections from a finite list of pre-defined room models based on, for example, a best-fit algorithm. Once the model is created or selected, the model may then be transmitted to the local computing device, a BMS, or a thermostat/hub in order to be executed. In some embodiments, a model may comprise a list of one or more parameters, including but not limited to occupancy, user preferences, room thermodynamics, weather, cloud cover, illuminance, sound levels, air quality levels including CO₂, VOC, particle matter, temperature, humidity, beacon (Bluetooth beacon to detect Bluetooth devices such as smart phones), building envelope (dual paned glass, concrete, brick, carpet), room characteristics (door, window, south facing, etc), time and day of week, current airflow, temperature of supply and return air, season (winter, summer, etc), geographic location, or duct size.

In some embodiments, dynamic data may additionally be collected from one or more external sources, for example weather data, cloud cover data, occupancy, door and window state, building envelope (dual paned glass, concrete, brick, carpet), room characteristics (door, window, south facing, etc), geographic location, duct size. In some embodiments, static data or environment data may also form part of the model, for example room geometry, window size, construction material, equipment or equipment state, occupancy, user preferences, room thermodynamics, weather, cloud cover, illuminance, sound levels, air quality levels including CO₂, VOC, particle matter, temperature, humidity, beacon (Bluetooth beacon to detect Bluetooth devices such as smart phones), time and day of week, current airflow, temperature of supply and return air, and season (winter, summer, etc).

In combination, the sensor and static/dynamic external data may be used to model the thermodynamic properties of an individual room, for example how quickly the measured temperature rises or falls at different times of the day and with different parts of the HVAC system running, and what air supply temperatures and airflow rates are needed to maintain or change a temperature in a room.

Another aspect of the modeling of the disclosed methods and devices involves behavioral modeling of the individuals who work in the rooms being controlled. For example, different users may adhere to different occupancy patterns in different rooms. Different users may have higher or lower tolerance to temperature deviations from a predetermined set point. Over time, dependency patterns may emerge, for example a first user may occupy a first room more or less frequently depending on whether or not a second user is occupying a second room. Applied at scale, the thermodynamic and behavioral modeling may in some embodiments be combined to generate a comprehensive, holistic energy usage model for an entire multi-room building. The building model may be created in one embodiment by first creating models on a room by room basis, then optionally performing grouping and/or rolling up functions to create a single energy usage model for the building.

This system is advantageous over existing systems known in the art, which attempt to model from the top down, first grouping rooms, sometimes arbitrarily, then applying the same temperature profile to all rooms in the group without taking into consideration the individual external factors of each room. Such implementations can lead to undesirable temperature variations in a multi-room building, for example one office may have an air temperature inside that is much colder than a second office very close by, even though both offices may be of similar size and located in the same part of the building (and controlled as part of the same zone in the building's HVAC scheme).

In some embodiments, systems and methods of the invention include a dead-band range around a temperature set point in order to conserve energy. A dead band range can also be thought of as allowable error bars around the temperature set point. For example, if a set point for a room is 70° F., and a dead band of +/−2° F. is allowed, then the HVAC control system will allow the temperature in the room to float between 68° F. and 72° F. before taking any action. Such a dead band range prevents against underdamping in the control system, which can cause undesirable temperature fluctuations if a control system attempts to adhere too strictly to a set point. In various embodiments, suitable dead band ranges include, but are not limited to, +/−0.5° F., +/−1° F., +/−2° F., +/−3° F., +/−4° F., +/−5° F., +/−6° F., +/−7° F., +/−8° F., +/−9° F., or +/−10° F.

In some embodiments, systems and methods of the disclosure include metrics for occupant health. For example, a system may include sensors for measuring CO₂, CO, PM, or VOCs, sound, and luminance, and may compare such measurements with measurements of outside air to determine whether more fresh air may be necessary to circulate into one or more rooms of a building. Such systems can save energy by reducing or increasing the need for fresh air if indoor air conditions are sufficient or not to recirculate already-conditioned air. In some embodiments, such systems use an economizer, which is a device that allows more or less fresh air into a recirculating system.

In some embodiments, a system or method disclosed herein includes one or more programmable alerts tied to any measured metric as contemplated herein crossing an adjustable or predetermined threshold. For example, in one embodiment, an air quality alert may be set if CO₂, CO, PM, and/or VOC levels approach or exceed a predetermined safety threshold. In another embodiment, one or more alerts may be based on temperature or humidity measurements, where for example extremely high temperatures, high brightness, and/or low humidity in a space may indicate the presence of a fire, or high PM, CO, or CO₂ measurements may indicate a malfunction in some equipment.

The systems and methods disclosed may be further described using the below illustrative examples, which are understood not to be limiting to the disclosure or any aspect of the disclosure. In some illustrative examples below, different scenarios may be described related to climate control in one or more rooms of a multi-room building, for example offices. Although the examples presented below may relate to temperatures in offices, it is understood that the same principles may apply to any other subdivision of a multi-room structure, for example entry ways, hallways, kitchens, conference rooms, elevator cars, atriums, restrooms, etc.

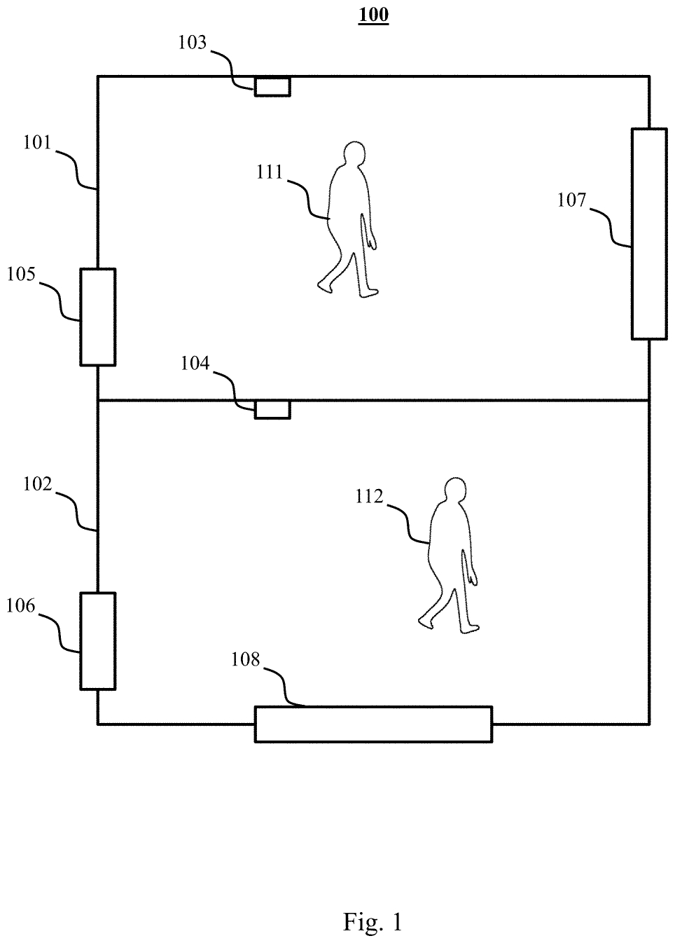

An exemplary implementation of the system 100 is shown in FIG. 1. In the depicted embodiment, two rooms 101 and 102 of a building are shown. In one example, the two rooms are offices in an office building. In the depicted example, the rooms 101 and 102 are similar in size, and room 101 has a door 105 while room 102 has a door 106. Both doors 105 and 106 are the same size and in the same position relative to the room. However, in the depicted embodiment, room 101 has a window 107 which faces a different direction than window 108 of room 102. In one example, where the building having the two rooms is positioned in the northern hemisphere, if the window 108 faces south while the window 107 faces east, room 102 will be exposed to significantly more sunlight during the course of a typical day than room 101. If both rooms 101 and 102 are tied to the same zone of a building's climate control system, and the temperature sensor for the zone was located at 103 in room 101, then room 102 would be expected to be significantly hotter in the winter months than both the desired set point and room 101, because the extra heating caused by the increased sun exposure through window 108 would not be measured as readily by the temperature sensor 103 in room 101.

In another embodiment, where the temperature sensor for the zone containing room 101 and room 102 was located instead at 104 in room 102, the temperature in room 101 would be expected to be significantly colder than both the desired set point and room 102, because the extra heating in room 102 would translate to a higher temperature reading at sensor 104, leading the HVAC system to believe that the set point was reached in the zone when in reality room 101 was colder than the set point, because window 107 does not let in as much excess solar energy as window 108.

In some embodiments, proximity sensors or other occupancy sensors may be positioned at 103 and 104, in order to detect the presence of occupant 111 in room 101 and occupant 112 in room 102. In various embodiments, proximity sensors of the disclosed system may be positioned in or on a wall, or in or on a ceiling, for example in a ceiling tile. Because the system 100 couples both rooms to a single zone, the presence of either occupant 111 or 112 will result in the heating or cooling of both room 101 and 102 to the common temperature set point, which results in significant excess energy use cooling or heating an unoccupied room. Additionally, if the temperature in rooms 101 and 102 is allowed to deviate significantly from the set point, for example allowed to fall to a very low temperature in cold months in order to conserve energy when no one is present, then it might take several hours for room 101, newly occupied by occupant 111, to heat up to an acceptable temperature.

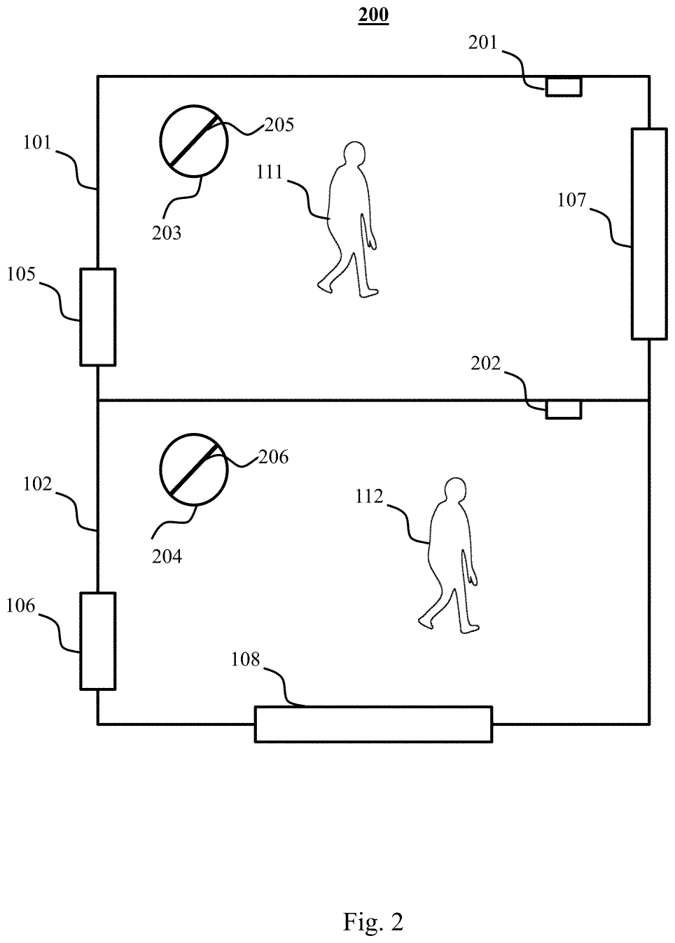

By contrast, a system of the disclosure may be described with reference to FIG. 2. The room layout is identical to the room layout in FIG. 1, but in FIG. 2, the simple temperature sensors are replaced with one or more sensor clusters 201, 202 in each individual room 101, 102. In various embodiments, sensor clusters of the disclosed system may be positioned in or on a wall, or in or on a ceiling, for example in a ceiling tile. Suitable sensors positioned in the sensor clusters include, but are not limited to, temperature sensors, humidity sensors, occupancy sensors, light sensors, sound sensors, CO₂ sensors, barometric pressure sensors, CO, PM, VOC, infrared, and ultrasonic sensors, and/or Bluetooth beacons. In one embodiment, a system of the disclosure includes one or more generic communication ports, for example USB, SPI, I2C, UART, Ethernet, Wi-Fi, Bluetooth, ZigBee, etc. and the ability to be expanded to communicate with any suitable type of sensor. Sensors may be positioned in the same housing with one another or may in some embodiments be spread throughout the room. The connected sensor clusters 201 and 202 may be communicatively connected to outside systems, as described in further drawings below, in order to process the data measured by the sensors and use the processed data to generate models for the rooms 101 and 102 and in some embodiments for the occupants 111 and 112. These models may in turn be used to exercise control over individual elements of the HVAC system, for example a temperature set point in one or both rooms, an allowed deviation from a temperature set point in one or both rooms, an airflow rate into one or both rooms, outside air (economizer—fresh air), hot or cold air, automatic window shades, windows, doors, lights, electrical outlets.

In one example, room 101 has at least one vent 203 positioned in the room, for example in the ceiling or in a wall of the room. Room 102 may also have at least one vent 204 positioned in the room, and vents 203 and/or 204 may include adjustable dampers 205 and 206. The dampers may in some embodiments be controllable to open or close, and may in other embodiments be controllable to remain partially open and adjustable, for example to allow a flow of 10%, 20%, 30%, 40%, 50%, 60%, 70%, 80%, or 90% of the full flow rate.

In some embodiments, adjustable dampers may be positioned at the outlet of the vent 203, but in other embodiments adjustable dampers may be built in to one or more ducts. In various embodiments, a single adjustable damper may control airflow into one or more rooms, or return airflow out of one or more rooms. More information about adjustable dampers suitable for use with the present disclosure may be found in U.S. patent application Ser. No. 16/040,573, filed Jul. 20, 2018 and incorporated herein by reference in its entirety.

In one example where, as discussed above, room 102 is exposed to more heat from the sun than room 101 by virtue of its south-facing window 108, damper 206 may close entirely or partially when the HVAC system is in a heating mode, in order to conserve energy by pumping less hot air into room 102 where it is already warm enough. By contrast, when the HVAC system is in a cooling mode, damper 206 may open entirely (while damper 205 may be partially or fully closed) in order to drive more cool air into room 102 in order to combat the heat from the sun through window 108. In this way, rooms 101 and 102 may more effectively be held at the same or a similar temperature, even though external factors cause disproportionate heating in one room or the other. Individually-controllable dampers may further increase energy efficiency of a system, because all the hot or cold air may be precisely routed only to the rooms or spaces within the building that need it most.

In one example, where room 102 has already reached its temperature set point, or a temperature that is within an acceptable deviation from the temperature set point, damper 206 may close entirely to stop pumping any conditioned air into room 102. However, in other embodiments, a thermodynamic model of room 102 may indicate that some level of maintenance air is needed in order to maintain the temperature set point. Therefore, some disclosed systems may direct damper 206 to close only partially, in order to allow conditioned air, recirculated air, filtered air, or fresh outside air into room 102 at a reduced flow rate. Such micro adjustments to air flow may assure that temperature is maintained efficiently, without going through hot/cold cycles as the HVAC system runs at full power, then turns off. In some embodiments, a system of the invention may further change either the damper openness or the HVAC heating/cooling power based on the temperature of intake air. For example, if an intake vent to a system is located in a room or space having an air temperature that is below a set point, and another room or space in the building has a measured ambient air temperature that is above a different or the same set point, a system of the disclosure may draw air in through the intake vent and pass it (optionally through a filtering, conditioning, or air processing element) into the second room in order to cool the second room with air from the first. In another embodiment, where the temperature of the intake air is measured to be hotter than the measured air temperature in the second room or space, the controller or hub may apply more aggressive conditioning or recirculation to the intake air before passing the conditioned air into the second room, in order to compensate for the higher air temperature at the intake side.

In some embodiments, a system of the disclosure may include electronically controllable shades or curtains for one or more windows 107, 108, so that shades may be closed or opened automatically as needed to allow more or less heat from outside.

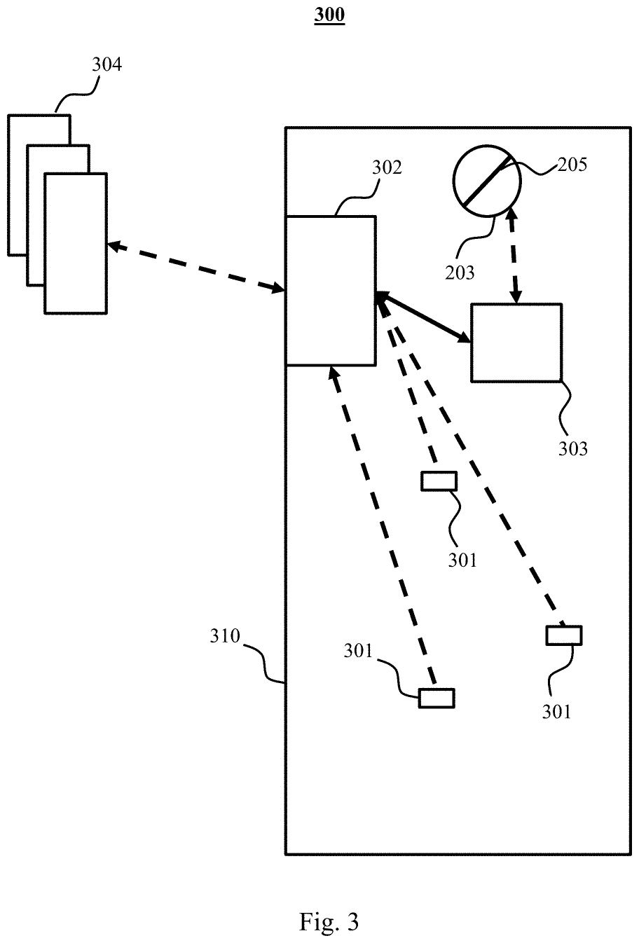

An exemplary architecture of a system of the disclosure is shown in FIG. 3. Architecture 300 includes one or more sensors 301 positioned throughout a building or structure 310, which further includes a controller or hub 302 communicatively connected to the one or more sensors 301. The communication links between sensors 301 and controller 302 may include one or more wired or wireless communication links as known in the art. The controller may in some embodiments be further connected to a building management system (not shown) or in other embodiments, the controller itself may be a building management system. The controller and/or building management system 302 may in some embodiments be communicatively connected to an HVAC system 303, which may in turn control one or more dampers 205 in vents 203.

In some embodiments, the one or more sensors 301 communicate unidirectionally with the controller or hub 302, but in other embodiments the communication link between one or more sensors 301 and the controller 302 may be bidirectional, for example to allow for configuration or other instructions to be transmitted from the controller 302 to the sensors 301. In some embodiments of a disclosed method, a controller may send any suitable instructions to one or more sensors, including but not limited to instructions to start or stop collecting data, or instructions to sample data at a greater or lesser interval, or instructions to go into a low power mode, for example until a set time in the future or until a wakeup signal is received by the sensor or sensors.

In some embodiments, a sensor 301 as disclosed herein may be an off-the-shelf sensor device including a communication link, for example a wireless communication link, for unidirectional or bidirectional communication with a controller or hub. In some embodiments, one or more sensors may include a dedicated computing device positioned in the same housing or communicatively connected to the sensor housing, configured to acquire measurements from one or more sensors, in some embodiments to process or perform calculations based on the raw data received from the one or more sensors, and then communicate the processed or calculated sensor data back to a hub or controller 302. In some embodiments, one or more sensors 301 may be an Internet of Things (IoT) sensor.

In addition to the in-building connections, the controller or building management system 302 may in some embodiments be communicatively connected to one or more remote computing devices 304, which may in different embodiments be servers or cloud instances or cloud compute resources configured to perform data analysis and use machine learning to generate models of one or more rooms in building 310 based at least in part on data collected from sensors 301 as well as a history of control actions taken by controller and/or BMS 302 and HVAC device 303. In one embodiment, the controller 302 may gather data from one or more sensors 301 and communicate that data to computing device 304, which may combine the collected sensor data with data from other sources, for example information about the orientation/windows of the building 310, information about the temperature in adjacent rooms of building 310, upcoming weather forecast models or cloud cover models for the vicinity of building 310, state of any electrical or other equipment in the building 310 which may generate excess heat (for example, computers), presence of a large number of people in a certain space (for example, a conference room hosting a meeting) where the high occupancy might generate more heat. In some embodiments, the collected data may include data about space heaters or coolers used by people to keep warm or cool, windows, doors, room characteristics such as ceiling height, square footage, duct size, etc.

The computing device 304 may then use the collected data to calculate a model for one or more rooms in building 310. In some embodiments, as disclosed herein, a model for a room may comprise a set of parameters for use in calculating a temperature set point over time. In other embodiments, a model for a room may comprise a selection from a fixed list of room models, wherein the selection is the room model which most closely approximates the thermodynamic characteristics of the room in question. In some embodiments, one or more rooms in building 310 may be assigned the same or a similar model, but in other embodiments, all rooms in building 310 may be assigned different models or parameters from one another.

When combined with data about the relative position of the one or more rooms with respect to one another in building 310, the machine learning systems on servers 304 may further be able to use the one or more thermodynamic room models to construct a full thermodynamic model for the building 310.

A second aspect of the present disclosure is related to predictive occupancy. As the modern workforce embraces increased flexibility and remote work increases in popularity, it is not always safe to assume that every office will be consistently occupied during a given work week, or even that any individual office will be occupied by the same person or people from one day to the next. Significant energy savings may therefore be attained by accurately predicting which offices/rooms will be vacant on a given day, and configuring the HVAC system in a building to save energy in those rooms. The predictive occupancy aspect of the disclosure may in some embodiments be a Boolean (true/false) prediction of occupancy at some future point in time, or may be a data set or graph of the probability that a room may be occupied over time for a fixed time interval in the future, for example for the next ten minutes, 30 minutes, one hour, two hours, four hours, 12, 24, or 48 hours. In some embodiments, a method of the invention may include applying a threshold to a probability of occupancy to convert a probability value into a Boolean value. In some embodiments, a method of the invention may comprise obtaining a plurality of Boolean or numeric probability values from a plurality of different models and combining them, for example by averaging them, to calculate a composite probability of occupancy.

In one example, with reference to FIG. 2, if office 101 was predicted to be occupied on a given day while office 102 was predicted to be vacant, and HVAC controller might close damper 206 fully or partially, or may allow for greater deviation from a temperature set point in office 102 than in occupied office 101. For example, if during cold weather, a heating temperature set point across one or more rooms was 70 degrees Fahrenheit, a temperature set point in unoccupied office 102 may be allowed to deviate by 1, 2, 3, 4, 5, 6, 7, 8, 9, or 10 degrees from the set point. In such an example, the effective set point for a heating in unoccupied office 102 might be as low as 60 degrees Fahrenheit, while the effective set point for heating occupied office 101 might be 70 degrees Fahrenheit. With this adjustment, far less energy is wasted maintaining a high temperature in office 102.

In another example, a system takes into account the individual preferences of users in predictive occupancy. For example, user 111 may prefer her office to be cooler (e.g. 67° F.) than user 112, who may prefer his office to be warmer (e.g. 72° F.). This difference might be easily implemented in a traditional system where user 111 has her own office 101 while user 112 is assigned office 102. However, in one example, user 111 and user 112 share an office in a hoteling model or similar, and so each uses office 101 on alternating days. One feature of the predictive occupancy aspect of the invention is the ability to predict, with accuracy, not only whether an office will be occupied on a given day at a given time, but also which user will most likely occupy said office, and what their temperature preferences are. In this way, the HVAC system will be able to accurately adjust itself before the workday begins, so that the temperature in office 101 is appropriate for whichever user will be using it that day when that user arrives at the office.

The predictive occupancy model can further adjust itself to the work hour preferences of different users. In one exemplary embodiment, user 111 prefers earlier work hours, for example 6:00 am to 2:00 pm, while user 112 prefers a more traditional 9:00 am-5:00 pm. Once trained, the predictive occupancy model can properly adjust so that the appropriate spaces attain the appropriate temperature in time for the designated user's arrival, while also reclaiming lost energy by relaxing the temperature set point during periods of non-occupancy. In one example, a predictive occupancy model may allow the set point for user 111 to deviate beginning at 1:30 pm or 1:00 μm, in anticipation of user 111's departure.

In some embodiments, the thermodynamic model and the predictive occupancy model may be combined to form a more holistic predictive model. If occupancy can be predicted with relative certainty, then thermodynamic modeling may be used not only to adjust the behavior of the HVAC system to maintain a certain temperature, but also to schedule when an adjustment needs to be made in order to attain a certain temperature in a certain room at a time in the future. For example, if a thermodynamic model of a certain room indicates that under the current weather conditions, it will take about half an hour to increase the temperature by five degrees, and a predictive occupancy model for the room predicts that the room will be occupied starting at 8:00 am the following day, then a system of the invention may hold the room at a temperature five degrees colder than needed and begin warming up the room at 7:30 am, in order both to conserve energy overnight and attain the desired set temperature in time for the predicted occupancy. Similarly, if a room is currently occupied but the predictive occupancy model determines that the room will be unoccupied starting at 4 pm, but the thermodynamic model indicates that, under current weather conditions, the room temperature will drop by only one degree per hour if hot air is no longer circulated into the room, a system of the present invention may stop warming the room at 2 pm, knowing that the room should maintain a tolerable temperature of no lower than 2° F. below the set point during the time of predicted occupancy.

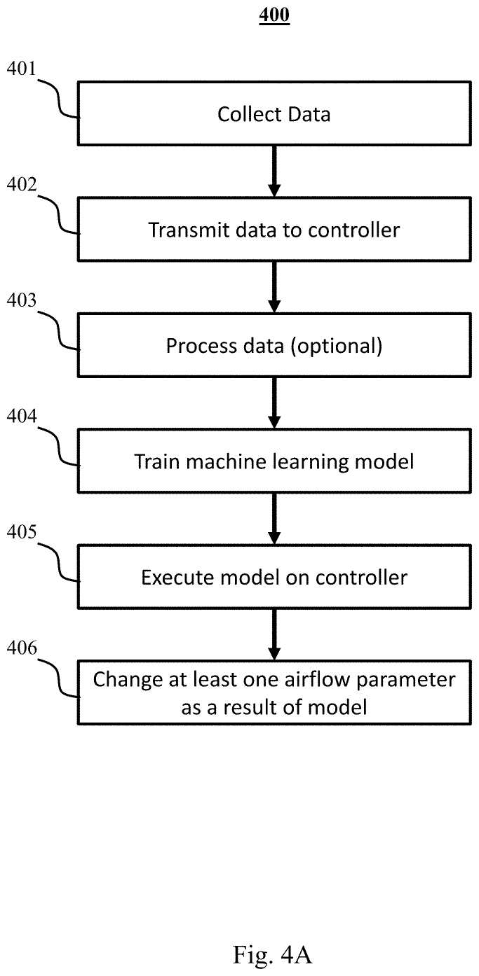

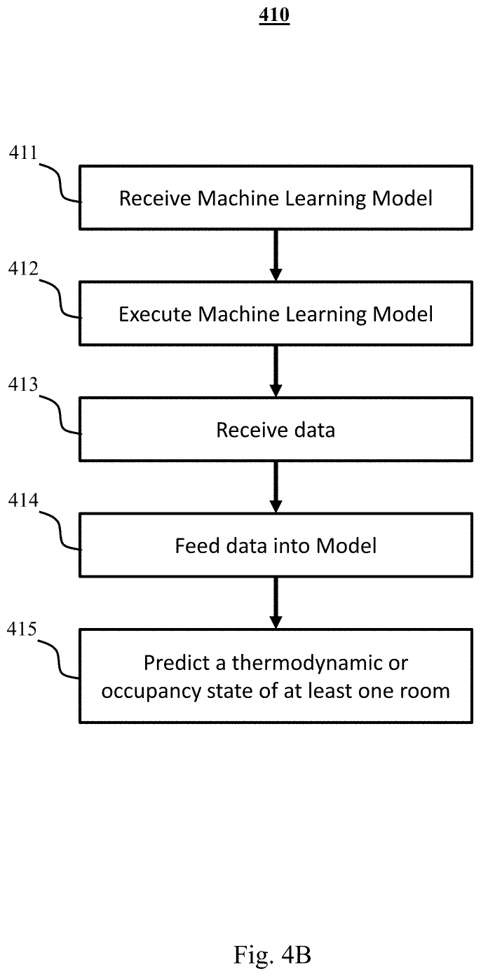

An exemplary method of operation of the disclosure may be described with reference to FIG. 4A and FIG. 4B. A first method 400 of training a machine learning model for use in an HVAC system includes the steps of collecting data from one or more sensors in a building in step 401, transmitting the data from the one or more sensors to a controller or hub in step 402, optionally performing a processing step on at least one element of data received from the one or more sensors in step 403, training a machine learning model to predict, based on the measured data, a thermodynamic model of a room in a building, an occupancy model for a room in a building, or a holistic model of thermodynamics and occupancy for a room in a building in step 404, executing the model on the controller in step 405, and changing at least one airflow parameter of an HVAC system as a result of the executed model in step 406.

Another exemplary method 410 is shown in FIG. 4B. The depicted method includes receiving, at a controller positioned in a building, a machine learning model in step 411, executing the machine learning model in step 412, receiving data from one or more data sources including sensors in the building, sensors outside the building, Internet data sources, BMS data which may incorporate some or all of the existing sensors in a building, sensors on all HVAC equipment including central plant, VAV boxes, other systems such as lighting systems, access control systems, fire/light/safety systems, other TOT companies, utility data for energy prices or energy models for cities or regions in step 413, optionally performing one or more processing steps on one or more of the received data elements in step 414, and feeding at least a subset of the received and/or processed data into the machine learning model to predict a thermodynamic and/or occupancy state of at least one room in the building in step 415.

What is claimed is:

1. A system for climate control, comprising:
a controller, comprising a processor and a non-transitory computer-readable medium with instructions stored thereon;
a plurality of sensors communicatively connected to the controller; and
at least one HVAC component communicatively connected to the controller;
wherein the instructions, when executed by the processor, perform steps comprising:
receiving sensor data from at least one sensor of the plurality of sensors;
executing a machine learning model using the received sensor data as inputs;
calculating a predicted temperature, humidity, or occupancy state from the machine learning model; and
sending a control instruction to the at least one HVAC component based on the calculated temperature, humidity, or occupancy state.

2. The system of claim 1, wherein the at least one sensor is selected from a temperature sensor, a humidity sensor, an occupancy sensor, a light sensor, a sound sensor, a CO₂ sensor, a barometric pressure sensor, a Bluetooth beacon, a CO sensor, a PM sensor, a VOC sensor, an infrared sensor, or an ultrasonic sensor.

3. The system of claim 1, wherein the at least one HVAC component is a building management system.

4. The system of claim 1, wherein the at least one HVAC component is selected from a controllable duct, an air handler, or a VAV box.

5. The system of claim 1, the steps further comprising sending a control instruction to a window, an automatic window shade, a door, a light, or an electrical outlet.

6. The system of claim 1, the steps further comprising calculating a predicted occupancy state from the machine learning model, and further comprising the step of scheduling a control instruction in a controller to be sent to at least one HVAC component based on the predicted occupancy state.

7. The system of claim 1, wherein the at least one sensor is a thermostat.

8. The system of claim 1, wherein the at least one sensor is positioned on a ceiling of a room.

9. The system of claim 1, the steps further comprising receiving environment data from at least one data source; and
executing the machine learning model using the environment data as additional inputs.

10. The system of claim 9, wherein the environment data is selected from room geometry, window size, construction material, equipment or equipment state, user preferences, room thermodynamics, weather, cloud cover, illuminance, sound levels, air quality levels including CO₂, VOC, particle matter, time and day of week, current airflow, temperature of supply and return air, or season.

11. A method for training a machine learning algorithm for a climate control system in a building, comprising:
collecting data from a plurality of sensors in a building;
transmitting the sensor data to a controller located in the building;
transmitting at least a subset of the sensor data to a remote computing device located outside the building;
training a machine learning model to calculate a predictive thermodynamic, occupancy, or holistic model of at least one room in the building;
transmitting the calculated model to the controller;
executing the model on the controller; and
transmitting the results of the executed model and additional measured sensor data to the remote computing device to refine the calculated model.

12. The method of claim 11, further comprising collecting environment data about the building; and
training the machine learning model additionally based on the collected environment data.

13. The method of claim 11, wherein the controller is a BMS.

14. The method of claim 11, further comprising the step of training the machine learning model to calculate a predictive thermodynamic, occupancy, or holistic model of at least a second room in the building.

15. The method of claim 14, further comprising the step of training the machine learning model to calculate a predictive thermodynamic, occupancy, or holistic model of an entire building based calculated models of each of the rooms in the building.

16. A method for HVAC control in a building, comprising:
receiving a machine learning model at a controller positioned in a building;
receiving data from a plurality of data sources at the controller;
providing at least a subset of the received data as inputs to the machine learning model;
predicting a future thermodynamic or occupancy state of at least one room in the building using the machine learning model; and
transmitting a control instruction to at least one HVAC component based on the predicted thermodynamic or occupancy state.

17. The method of claim 16, wherein the data sources comprise sensors and environment data.

18. The method of claim 17, wherein the sensors are selected from a temperature sensor, a humidity sensor, an occupancy sensor, a light sensor, a sound sensor, a CO₂ sensor, a barometric pressure sensor, a Bluetooth beacon, a CO sensor, a PM sensor, a VOC sensor, an infrared sensor, or an ultrasonic sensor.

19. The method of claim 17, wherein the environment data is selected from room geometry, window size, construction material, equipment or equipment state, user preferences, room thermodynamics, weather, cloud cover, illuminance, sound levels, air quality levels including CO₂, VOC, particle matter, time and day of week, current airflow, temperature of supply and return air, or season.

20. The method of claim 16, further comprising recording a value of a parameter of the at least one room after transmitting the control instruction; and
refining the machine learning model with the recorded parameter values.
